(19) United States
(12) Patent Application Publication
(10) Pub. No.: US 2018/0126598 A1
(43) Pub. Date: May 10, 2018

(54) METHOD AND SYSTEM FOR AUTOMATED FABRICATION OF COMPOSITE PREFORMS

(71) Applicants: Jonathan Worthy Hollander, San Francisco, CA (US); Eric Gregory, Larkspur, CA (US); Ashish A. Choudhari, San Francisco, CA (US); Jesica E. Ferro, San Francisco, CA (US); Gregory E. James, San Francisco, CA (US); Maxwell Shimshak, San Francisco, CA (US); Benjamin D. Voiles, San Francisco, CA (US)

(72) Inventors: Jonathan Worthy Hollander, San Francisco, CA (US); Eric Gregory, Larkspur, CA (US); Ashish A. Choudhari, San Francisco, CA (US); Jesica E. Ferro, San Francisco, CA (US); Gregory E. James, San Francisco, CA (US); Maxwell Shimshak, San Francisco, CA (US); Benjamin D. Voiles, San Francisco, CA (US)

(73) Assignee: Seriforge, Inc., San Francisco, CA (US)

(21) Appl. No.: 15/805,068

(22) Filed: Nov. 6, 2017

Related U.S. Application Data
(60) Provisional application No. 62/419,443, filed on Nov. 8, 2016.

(51) Int. Cl. B29B 11/04; B29C 65/62; B29B 11/16; B32B 7/08; B32B 5/06

(52) U.S. Cl. CPC B29B 11/04; B29C 65/62; B32B 2313/04; B32B 7/08; B32B 5/06; B29B 11/16

(57) ABSTRACT

A method and system for automated fabrication of composite preforms. In one implementation, a fabrication apparatus includes a stitching assembly, needle apparatus, motion stage, preform cartridge, CAD/CAM Software, and embedded machine software. The stitching assembly includes an upper portion that supports a stitching mechanism. The stitching mechanism includes at least one needle assembly. The needle assembly may be configured with at least one needle apparatus configured to pass filaments through composite preforms. In one implementation, the stitching assembly is used to stitch layers of the composite preforms using a variety of stitching patterns. The fabrication apparatus may be configured to fold fabric layers of the composite preform before or after stitching two or more layers of the composite preform.

### CROSS REFERENCES TO RELATED APPLICATIONS

This application claims the benefit of U.S. Provisional Patent Application Ser. No. 62/419,443, entitled METHOD AND SYSTEM FOR AUTOMATED FABRICATION OF COMPOSITE PREFORMS, filed on Nov. 8, 2016, which is hereby incorporated by reference as if set forth in full in this application for all purposes.

### BACKGROUND

The present invention relates to the field of fiber-reinforced composite materials, and in particular to methods and devices for manufacturing composite preforms and finished composite products with complicated three-dimensional shapes.

Fiber-reinforced composite materials, referred to herein as composites, are materials comprised of fibers embedded in a matrix material. Typical fibers include but are not limited to glass fibers, carbon fibers (e.g. graphite fibers and/or more exotic forms of carbon, such as carbon nanotubes), ceramic fibers, and synthetic polymer fibers, such as aramid and ultra-high-molecular-weight polyethylene fibers. Typical matrix materials include polymers, such as epoxies, vinylesters, polyester thermosetting plastics, phenol formaldehyde resins, cement, concrete, metals, ceramics, and the like.

Composite materials often combine high-strength and relatively low weight. In typical composite products, the fibers provide high tensile strength in one or more directions and the matrix material hold the fibers in a specific shape. A set of fibers roughly in the shape of a final product is referred to as a composite preform. Typical prior composite preforms are comprised of layers of fibers, which are often woven or bound into a sheet of fabric that are cut and arranged into a desired shape. Because fibers and fabrics made from fibers only provide high strength in specific directions, multiple layers of fiber cloth are often stacked in different orientations to provide strength and stiffness optimized for the intended usage of the final product.

Most prior composite manufacturing techniques require the production of some type of mold, mandrel, plug, or other rigid structure in the shape of the desired preform. Sheets of fiber fabric are then cut and arranged on this rigid structure. A matrix material, such as uncured polymer resin, may be embedded in the fiber fabric or applied to the fabric during or after the fabric layup process. The matrix material is then cured or hardened, often under elevated temperature and/or pressure differentials to ensure even distribution of the matrix material and prevent voids, air bubbles, or other internal defects. Pressure and/or temperature may be applied to the composite part during curing using techniques including compression molding, vacuum bags, autoclaves, inflatable bladders, and/or curing ovens, etc.

Unfortunately, prior techniques for manufacturing composite preforms and final composite parts, especially for complex part shapes, are time-consuming and difficult to automate. For example, creating a mold, mandrel, or other rigid structure for supporting the preform is costly and time-consuming, especially for custom parts or small production runs where the tooling cost and time cannot be amortized over a large number of parts. Moreover, the cutting and/or arranging fabric in the mold or other rigid structure is often performed by hand, due to the difficulty in draping fabric over complex forms without wrinkles or other surface defects. As a result, composite products are much more expensive than equivalent products made using conventional materials.

Therefore, what is needed is a fabrication apparatus and method for manufacturing composite preforms and final composite parts that overcomes the limitations of the prior art.

### BRIEF DESCRIPTION OF THE DRAWINGS

Implementations will be described with reference to the drawings, in which:

FIGS. 1A and 1B illustrate a fabrication apparatus for manufacturing composite preforms according to implementations described herein.

FIG. 2 is a high-level illustration of stitching assembly for use with implementations described herein.

FIGS. 3A-C illustrate a high-level view of a stitching assembly and example actuation assemblies for use with implementations described herein.

FIG. 4 is a high-level illustration of XY motion control signals used to control a preform motion stage for use with implementations described herein.

FIG. 5 is a high-level flow diagram for a method of manufacturing composite preforms and finished composite products with complicated three-dimensional shapes for use with implementations described herein.

FIGS. 6A-B are high-level illustrations of a composite preform stack and composite preform for use with implementations described herein.

FIGS. 7A-B are high-level illustrations of composite preform layer stacking for use with implementations described herein.

FIGS. 8A-D are high-level illustrations of composite preform layer stacking for use with implementations described herein.

FIGS. 9A-D are high-level illustrations of composite preform layer folding for use with implementations described herein.

FIGS. 10A-D are high-level illustrations of a composite preform stacking and folding for use with implementations described herein.

FIGS. 11A-C are high-level illustrations of composite preform cartridges for use with implementations described herein.

FIG. 12 is are high-level illustration of a composite preform cartridge and cartridge holder for use with implementations described herein.

FIG. 13 is a high-level illustration of a continuous stitch used with implementations described herein.

FIGS. 14A-C illustrate high-level side views of operations of a needle assembly in different stages of stitching composite preform layers for use with implementations described herein.

FIGS. 15A-C illustrate high-level side views of operations of a needle assembly in different stages of stitching composite preform layers for use with implementations described herein.

FIGS. 16A-G illustrate a high-level perspective views of operations of a needle assembly in different stages of stitching composite preform layers for use with implementations described herein.

FIGS. 17A-C illustrates example composite preform or finished products manufactured using systems and methods implementations described herein.

FIG. 18 illustrates a computer system suitable for controlling a system for three-dimensional weaving of composite preforms and products with varying cross-sectional topology according to implementations described herein.

### SUMMARY

Implementations include a system that includes a fabrication apparatus and method for creating composite preforms through a process of stacking, stitching, and folding two-dimensional fiber fabric piles. In some implementations folding preform supports are used to fold carbon fabric piles into 3D shapes. Each layer of carbon fiber fabric may have a different shape than the other layers and any arbitrary topology, potentially including non-convex and/or disjoint shapes. The carbon fabric piles may be stitched using a continuous fiber tow either before or after folding.

In another implementation, a continuous stitch may be employed to stitch a plurality of composite layers together. A stitching apparatus may be configured to provide the continuing stitching operation through varying laminate thicknesses and at varying Z heights relative to a Z base position. The continuous stitch may be configured to allow for composite layer movement relative to other composite layers to reduce stress points between composite layers during composite preform assembly.

### DETAILED DESCRIPTION

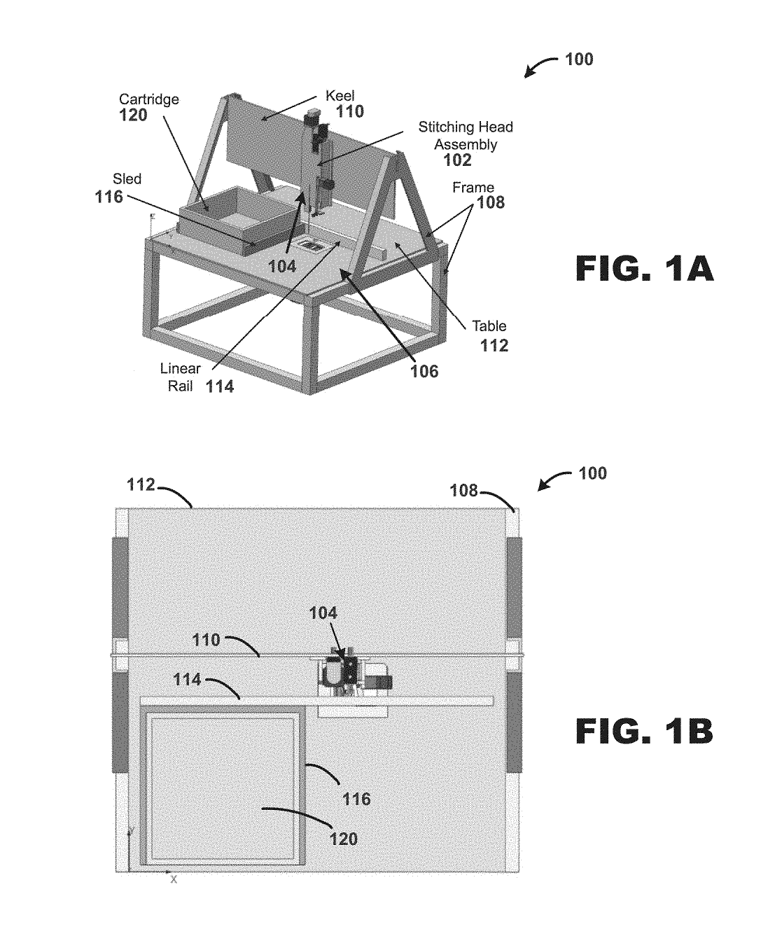

FIG. 1A is a perspective view and FIG. 1B is a top view illustrating a fabrication apparatus 100 for automated fabrication of composite preforms. In one implementation, fabrication apparatus 100 include a stitching assembly 102, needle apparatus 104, motion stage 106, supported by frame 108. Motion stage 106 includes keel 110, table 112, and linear rail 114, which are connected to frame 108. Keel 110 may be configured to support needle apparatus 104. Table 112 may be configured to support a sled 116 adapted to receive a preform cartridge 118 as described herein. As described herein, fabrication apparatus may be controlled by software such as CAD/CAM Software, embedded machine software, and the like. In an implementation, motion stage 106 is configured to move the composite preform relative to the stitching assembly 102 in order to create different stitching patterns used to stitch layers of fabric together forming the composite preforms.

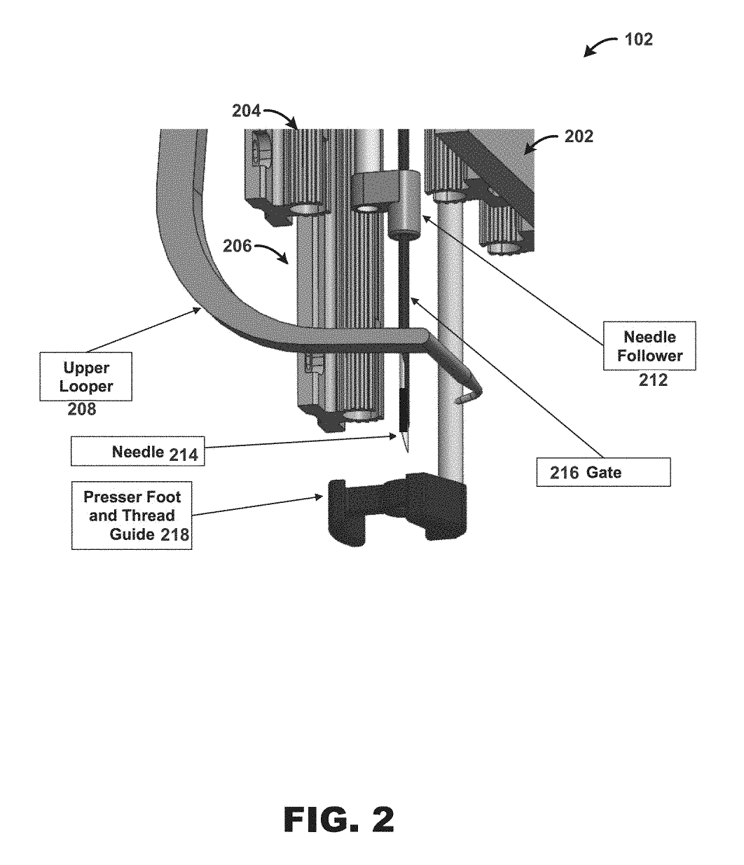

FIG. 2 is a high-level illustration of stitching assembly 102 for use with implementations described herein. Stitching assembly 102 includes an upper portion 202 that supports a stitching mechanism 204. Stitching mechanism 204 includes a needle assembly 206, upper looper 208, and needle follower 212. Needle assembly 206 may be configured with at least one needle 214 configured to pass filaments through carbon fiber, fiberglass, aramid, and the like, or other material preform, and a gate 216.

In an implementation, stitching assembly 102 includes a pressure foot 216 and thread guide 218 disposed in axial alignment with needle apparatus 210. During a stitching process as described herein, upper looper 208, needle 210, and gate 212 operate with presser foot 214 and thread guide 216 to stitch two or more carbon fiber fabric plies together.

Needle 214 may include a central shaft having a thread-bearing eye which may be open on one side in “C” shape eye, or the like, configured for thread control, and may include one or more smoothed inner surfaces to prevent damage to the filament. In some implementations, needle 214 may have a beveled tip to assist in spreading filaments.

In an embodiment, gate 216 consists of an outer tube (referred to as the “gate”), which is configured to ride on the needle shaft with a tongue at the end that covers the opening of the eye. Gate 216 may end in a sharp point for penetrating fabric and spreading filaments. Gate 216 may be adapted to move axially relative to needle 214 to expose or cover the opening of the eye. This gate motion allows the filament to be removed from and reinserted into the eye during portions of the stitch cycle, as illustrated herein.

Upper looper 208 may be used to hold the filament during the stitching process and to take up excess filament as stitches are formed.

Needle follower 212 supports the end of needle 214 and prevents needle buckling and excessive deflection by following needle 214 from a needle's top or initial position during the stitching process to a position just above the preform surface.

Presser foot and thread guide 218 may be used to apply pressure to the preform surface during stitching to prevent the preform fabric from “tenting” up as needle 214 is withdrawn. Presser foot and thread 216 guide may also include surfaces for guiding the filament as stitches are formed to ensure that the filament remains in the correct position for stitch formation.

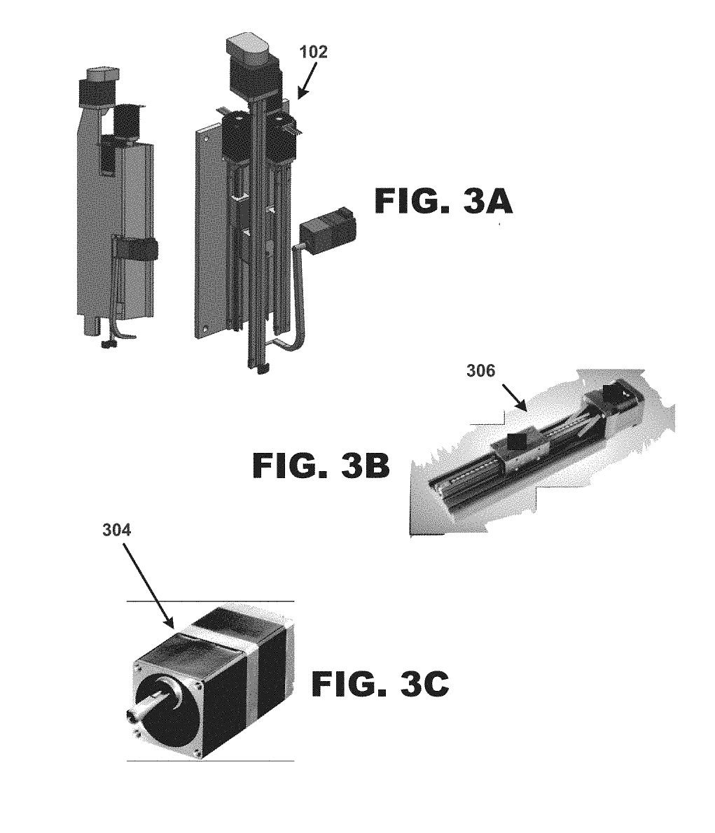

FIGS. 3A-C illustrate stitching assembly 102 and associated high-level actuation assemblies 304 and 306 for use with implementations herein. Stitching assembly 102 may be configured to provide a continuous stitch as described herein.

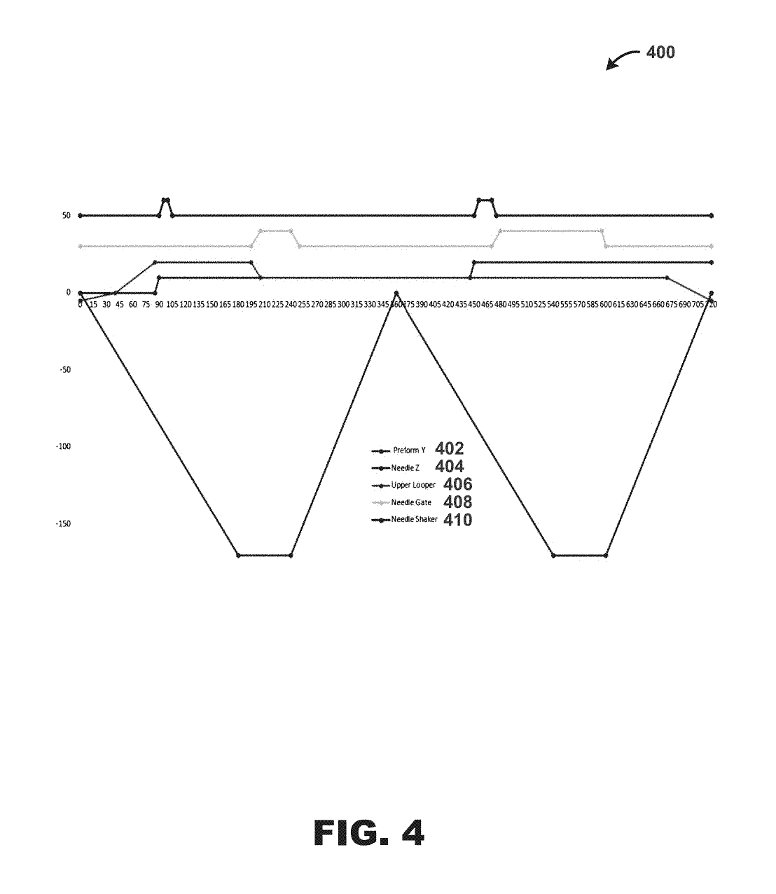

FIG. 4 is a high-level illustration of XY motion control signals 400 used to control preform motion stage for use with implementations herein. In one implementation, motion control signals 400 include a preform Y control signal 402 used to control the preform Y axis direction, a needle Z direction control signal configured to control the Z-depth of the needle penetration relative to a Z-base position, upper looper control signal 406, needle gate control signal 408, and needle shaker control signal 410. For example, motion control signals 400 may be configured to operate with fabrication apparatus 100 to control motion stage 106 to process and manufacture preforms.

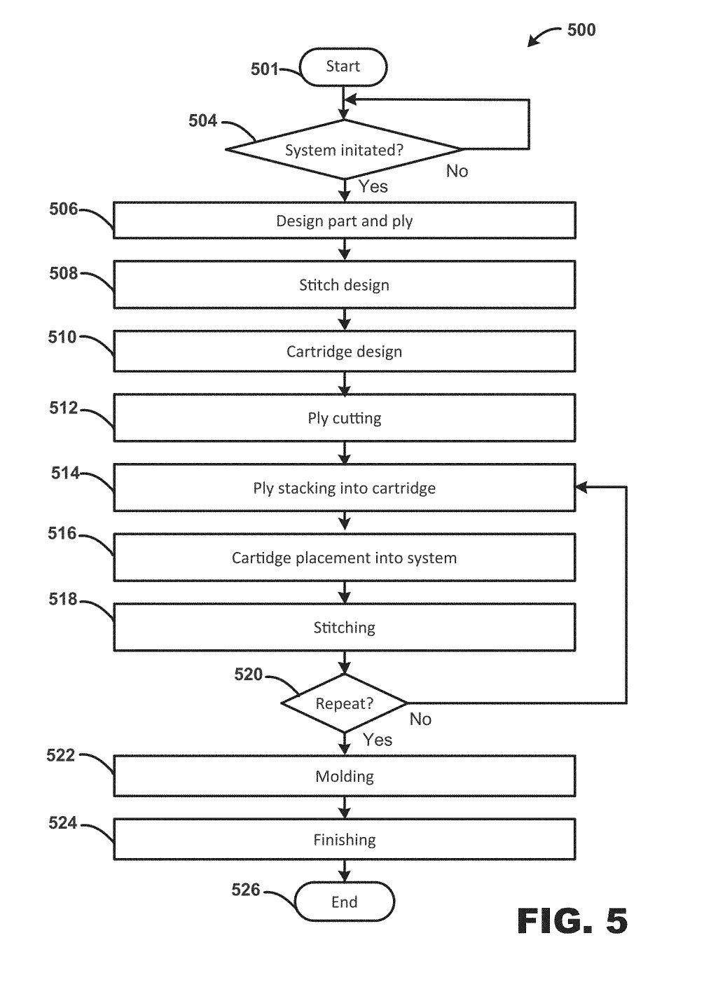

FIG. 5 is a high-level flow diagram for a method 500 of manufacturing composite preforms and finished composite products with complicated three-dimensional shapes for use with implementations herein. In one implementation, at step 501 when method 500 is invoked, for example, when a preform fabrication is initiated. At 502 method 500 determines whether a preform fabrication system, such as fabrication apparatus 100, has been initiated.

In one implementation, at step 506 a part and ply are designed, for example, using a CAD/CAM program. The design may include the number of layers of carbon fabric, type of bends or folds required, etc. At step 506, method 500 determines a stitch design. For example, a stitch design may include the number of stitches, type of stitch, depth of stitch, Z-height of stitch, etc., which may be converted to control signals 400.

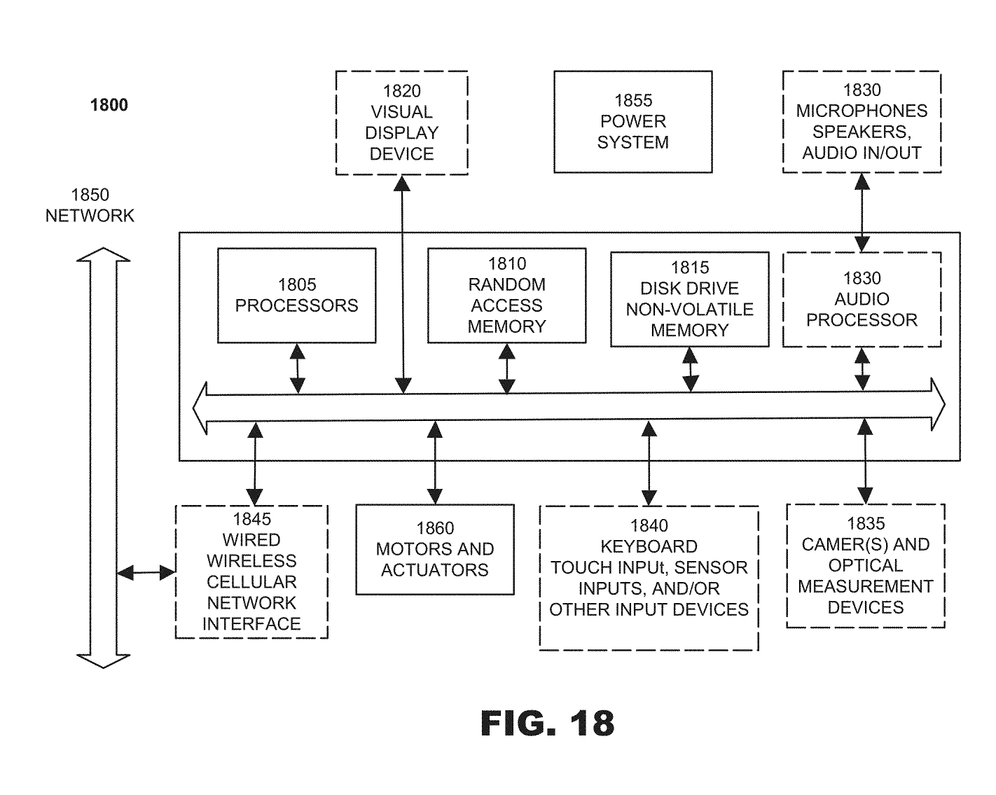

At step 508 a stitch is designed. For example, a stitch design may include determining the type of stitch, length of stitch, pattern of stitch, and the like. In an implementation a continuous stitch may be used as illustrated in FIG. 18, described further herein.

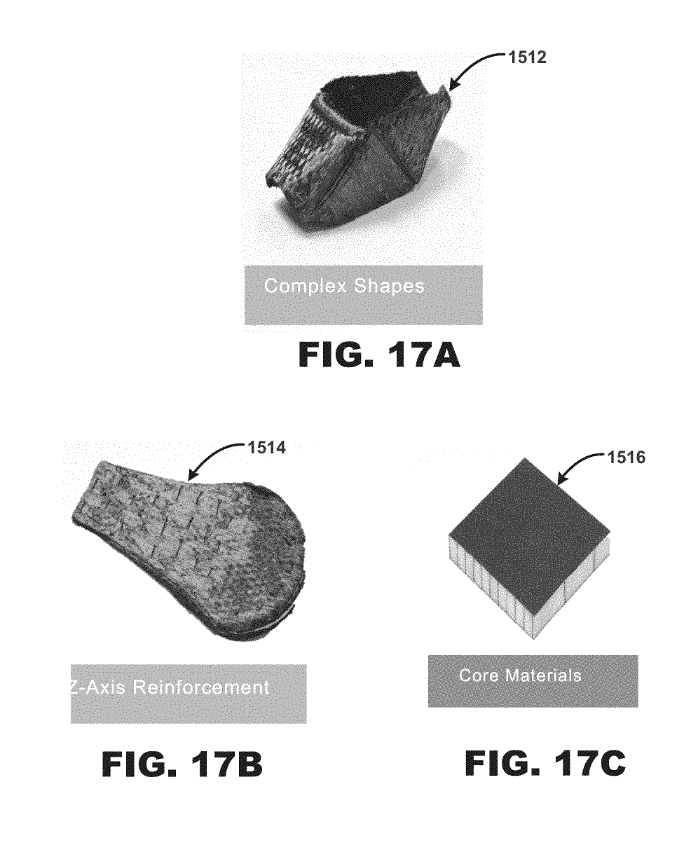

At step 510 a preform cartridge 120 may be designed for use with fabrication apparatus 100. In an implementation, a preform cartridge design may include a preform cartridge 120 as illustrated in FIG. 17. Such preform cartridge design may include design of fabrication components used with perform cartridge 120 such as holding brackets, enclosures, etc., for use by fabrication apparatus as described herein.

At step 512, plies of fiber fabric are cut relative to the preform or finished part design. Ply cutting may involve any type of cutting that may be used to advantage such as a rotary blade, drag knife, vibrating blade, ultrasonic knife, die cutting, laser cutting, water jet cutting, and the like.

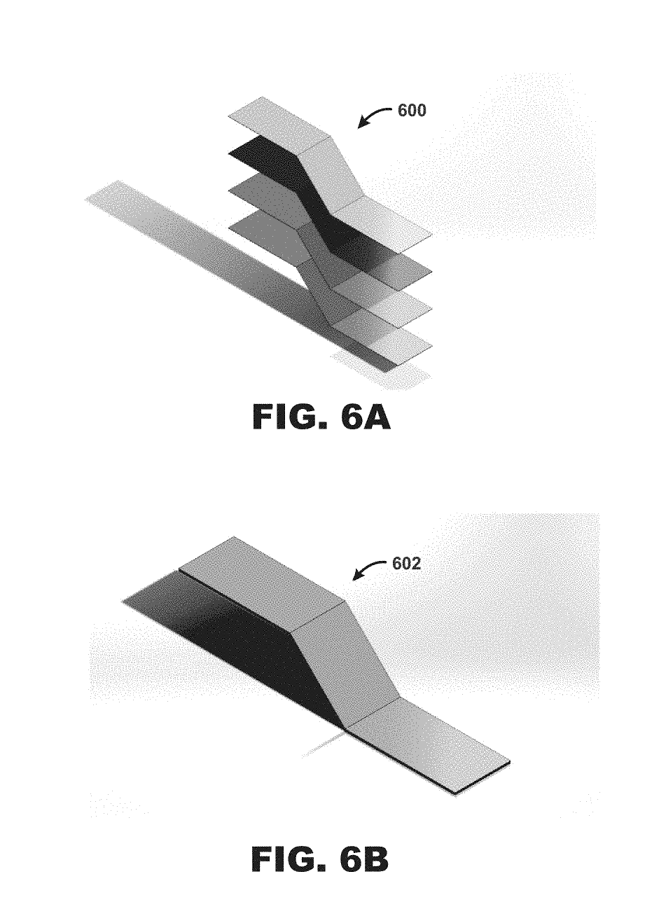

At step 514, plies of fiber fabric as stacked into an initial shape that may be the end shape or an intermediate shape that is later folded into a final or end stage shape. For example, in one implementation as illustrated in FIGS. 6A and 6B, layers 600 of carbon fiber fabric are stacked into a composite preform 602 that may be placed into a cartridge for stitching as described herein.

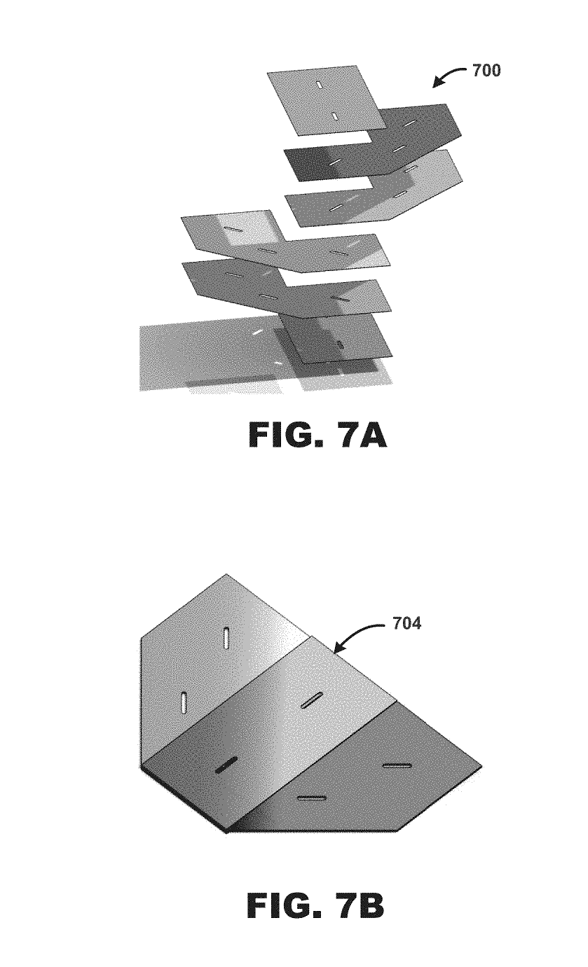

In another example illustrated in FIGS. 7A and 7B, plies of fiber fabric 700 may be cut into various shapes and stacked. The stacking process may include sequentially stacking and orienting a plurality of layers, such as layer 704.

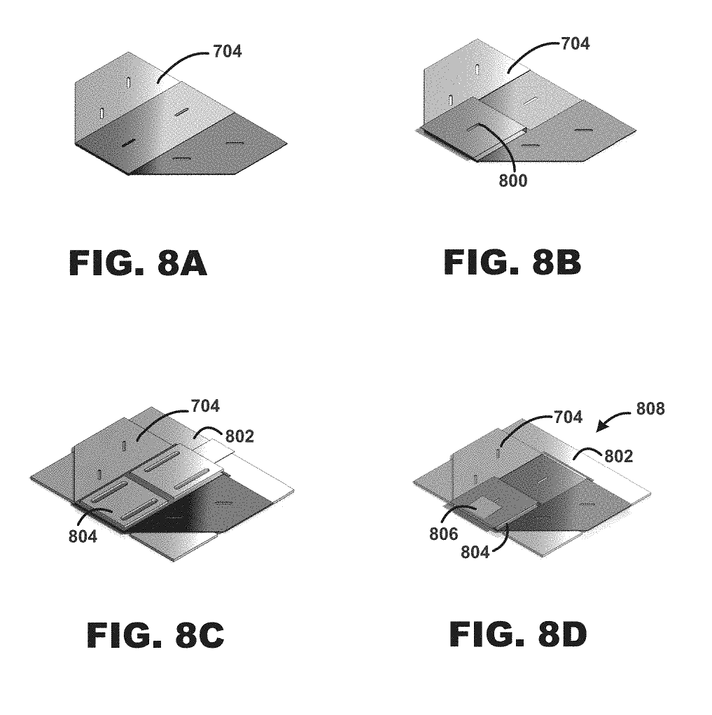

In exemplary implementations, fabric layers may be stacked and folded before or after stitching. For example, as illustrated in FIG. 8A, layer 704 is placed in position for stacking. FIG. 7B illustrates layer 800 may be stacked on top of layer 704. FIG. 8C illustrates layer 802 may be stacked underneath layer 704 and layer 804 may be stacked on top of layer 800, and FIG. 8D illustrates layer 806 being stacked on layer 804 to form composite preform 808.

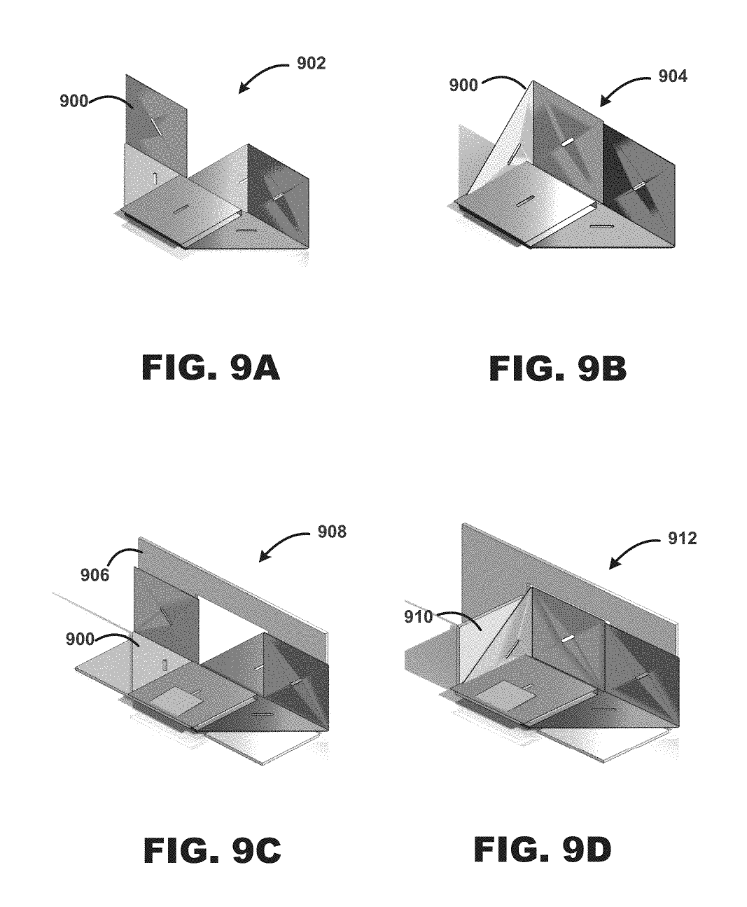

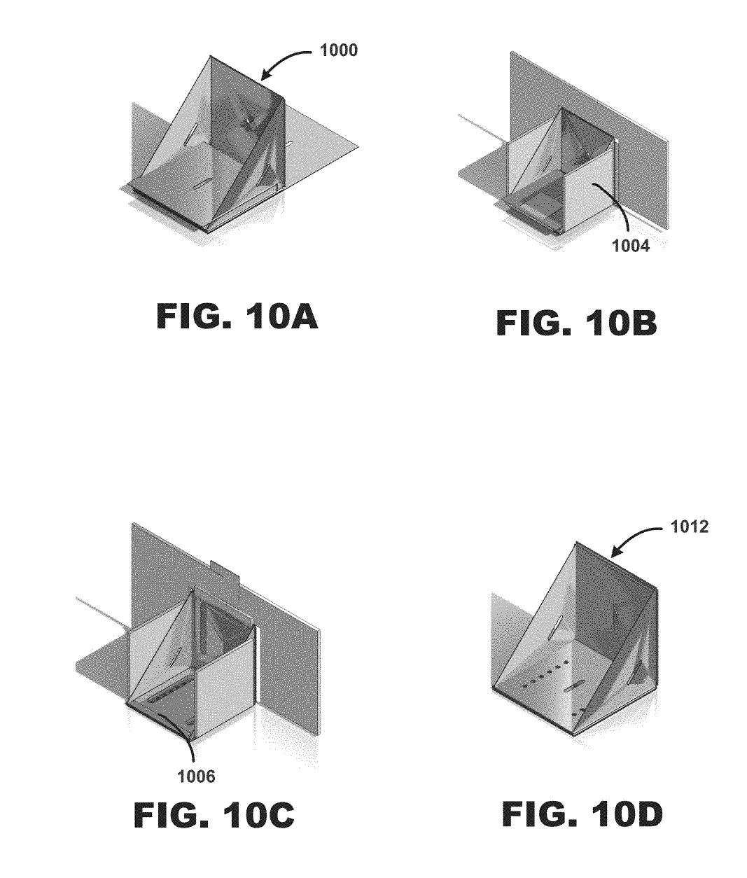

In an implementation, as illustrated in FIG. 9A, stacked plies of fiber fabric 900 may be folded, before, during, or after stitching to form an intermediary composite preform or final composite preform 902. FIG. 9B illustrates folding one or more fiber fabric layers 900 to form intermediary composite preform form or final composite form 904. Implementations may use manual or actuated hinged panels and other fabric manipulating mechanisms to fold portions of fabric layers into an intermediate or final composite preform shape. FIG. 9C illustrates an example actuated hinged panel 906 folding fabric layers 900 into an intermediate preform shape 908. Similarly, FIG. 9D illustrates a second actuated hinged panel 910 that folds the preform into a further intermediate preform shape 912. FIGS. 10A-10D illustrate additional folding mechanisms 1000, 1004, and 1006 that fold this example preform through additional intermediate shapes into the final preform shape 1012.

In one implementation, additional plies of fiber fabric may be added to folded stacks which are then additionally folded before, during, or after stitching

In some implementations, the fabric manipulating mechanisms such as hinged panels 906 and 910 may be integrated into a cartridge, so that the preform does not need to be removed from the cartridge until the preform assumes its final shape prior to molding.

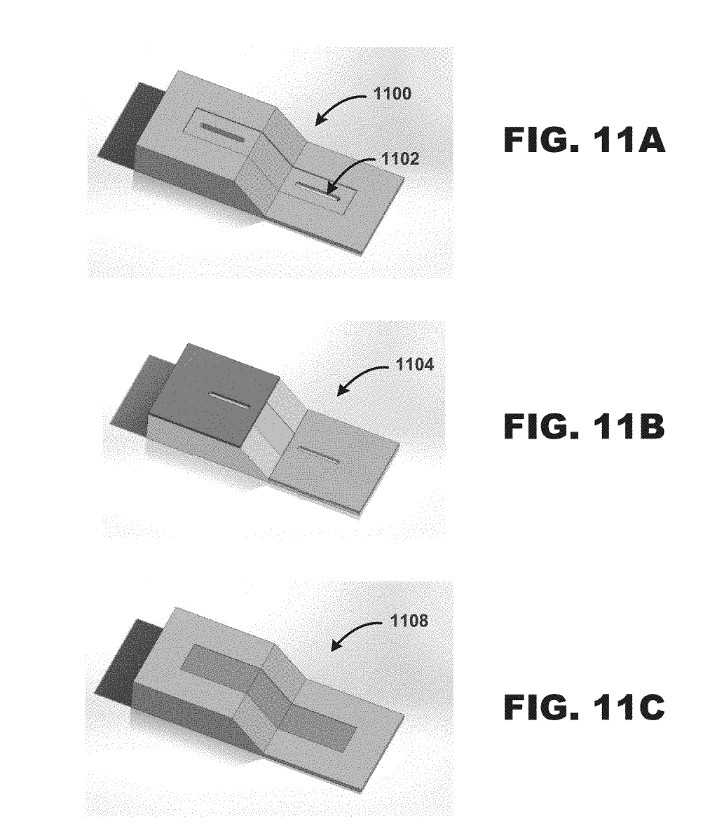

Further, at step 514, the stacked and/or folded plies of fiber fabric folded may be inserted into cartridges for stitching or finishing into a composite preform. For example, FIG. 11A illustrates a cartridge 1100 used for holding a stacked and/or folded composite preform, such as composite preform 602, having an access recess 1102 for a stitching process as described herein. FIG. 11B illustrates a cartridge 1106 used for holding a stacked and/or folded composite preform for a pre-assembly stage or final stage of processing. FIG. 11C illustrates a cartridge 1108 used for holding a stacked and/or folded composite preform assembly for a pre-assembly stage or final stage of processing.

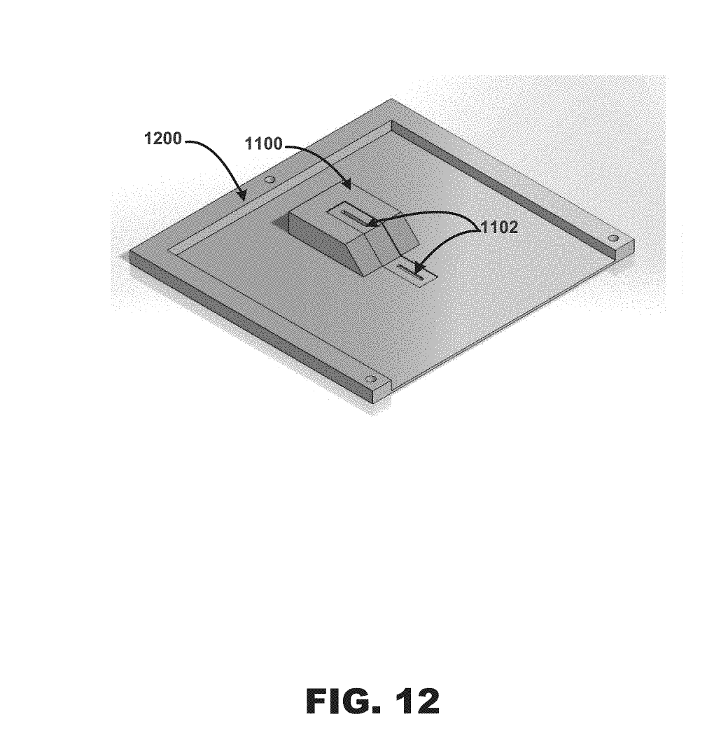

At step 516, method 500 places composite preforms into a cartridge fixture that holds the fabric layers in the correct position and orientation prior to and during stitching. For example as shown in FIG. 12, cartridge 1100 may be held by cartridge holder 1200. As illustrated in FIG. 1, cartridge holder 1200 may be configured to be inserted into sled 116 for processing as described herein. As described above, cartridge 1100 may include an opening 1102, such as slots, holes, and the like, above and below the fabric layers to allow passage of needle 214 and filament while supporting the fabric layers close to each stitch. Cartridges 1200 may hold preforms in flat or substantially planar configurations, or drape fabric layers on three-dimensional, non-planar surfaces. Cartridges 1100 may use vacuum, physical clamping, adhesives, or other mechanism to hold fabric layers in a desired shape during stitching.

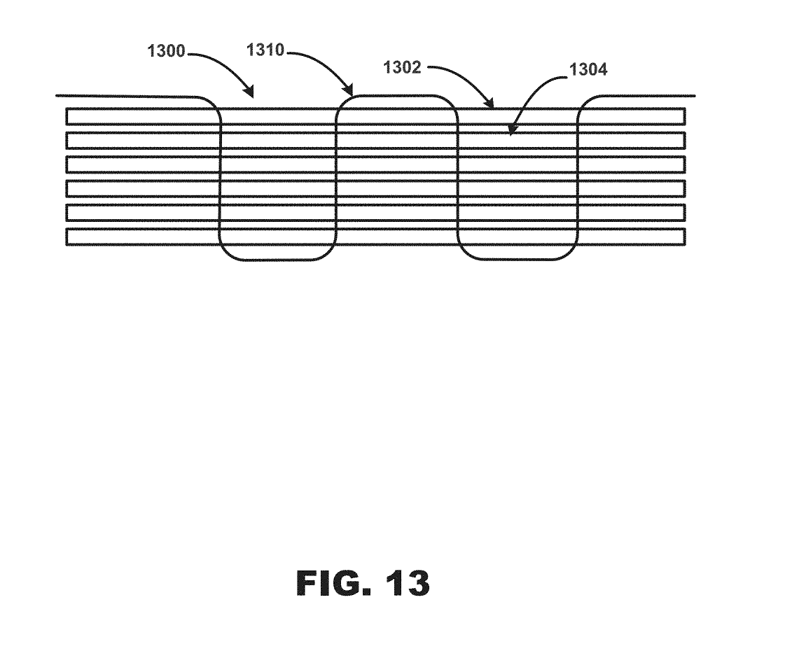

At step 518, a composite preform, may be stitched at various Z heights relative to a Z base position, or reference point, in a stitching process using one or more stitches. For example, as illustrated in FIG. 13 layers of composite fabric 1300 are stitched together using a continuous stitch 1310. The continuous stitch may be configured to allow motion between layers 1300, e.g., layers 1302 and 1304, such that during a folding process layers 1300 may move relative to one another to relive stress points. Advantageously, such movement allows a composite preform to be stitched before or after folding without imparting stress points amongst layers 1300 thereby reducing or eliminating localized stresses on the composite preform fabric.

In some implementations, filaments, such as carbon, glass, aramid, or other fibrous or filament material may be stitched to join layers 1300 of composite preform 602. Filaments may include carbon tow as well as flat or twisted carbon yarns, optionally including wrapping to prevent fraying or wear. In one implementation, stitching mechanism 102 may be configured to utilize a number of different stitching patterns including a “205” hand stitching pattern, as described by ASTM standard D6193, to join the layers of the composite preforms. Following fabrication of the composite preform, the composite preform may be placed into a mold or tool for infusion with resin or other matrix material, for example using vacuum or high-pressure infusion.

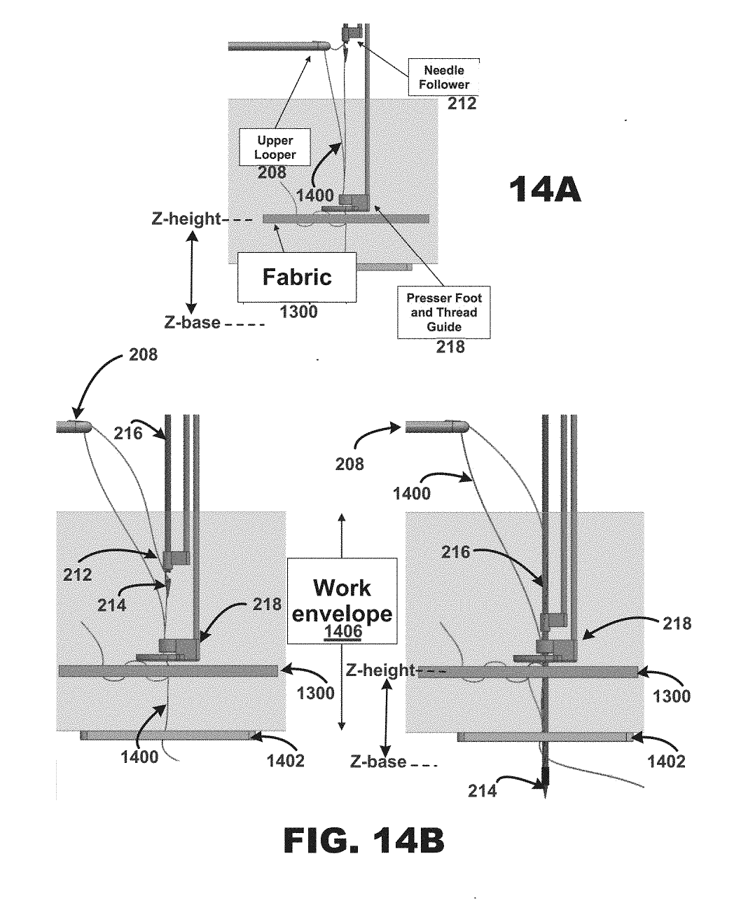

As illustrated in FIGS. 14A-14C, a filament 1400 for stitching is placed in the needle eye, and gate 216 is lowered to close the eye and retain the filament 1400. A Z-height stitching position is established relative to a Z-base position or other reference point, such as surface of a layer, laminate, etc. to allow the stitching process to occur at virtually any location and accommodate any layer, laminate, or preform thickness within the work envelope 1406. Needle 214 and gate 216 are then lowered together through the fabric layers 1300 of the composite preform, carrying filament 1400 to the lower stitching unit 1402. During this motion, needle follower 212 trails the needle tip slightly until it reaches or approaches the top of the preform to support needle 214.

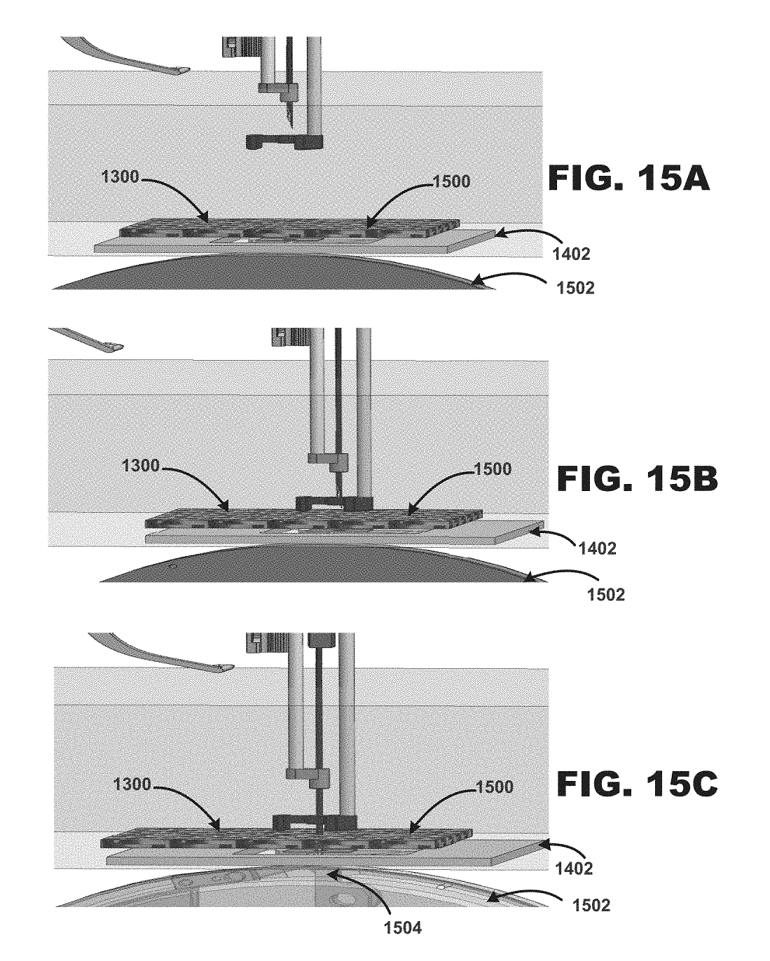

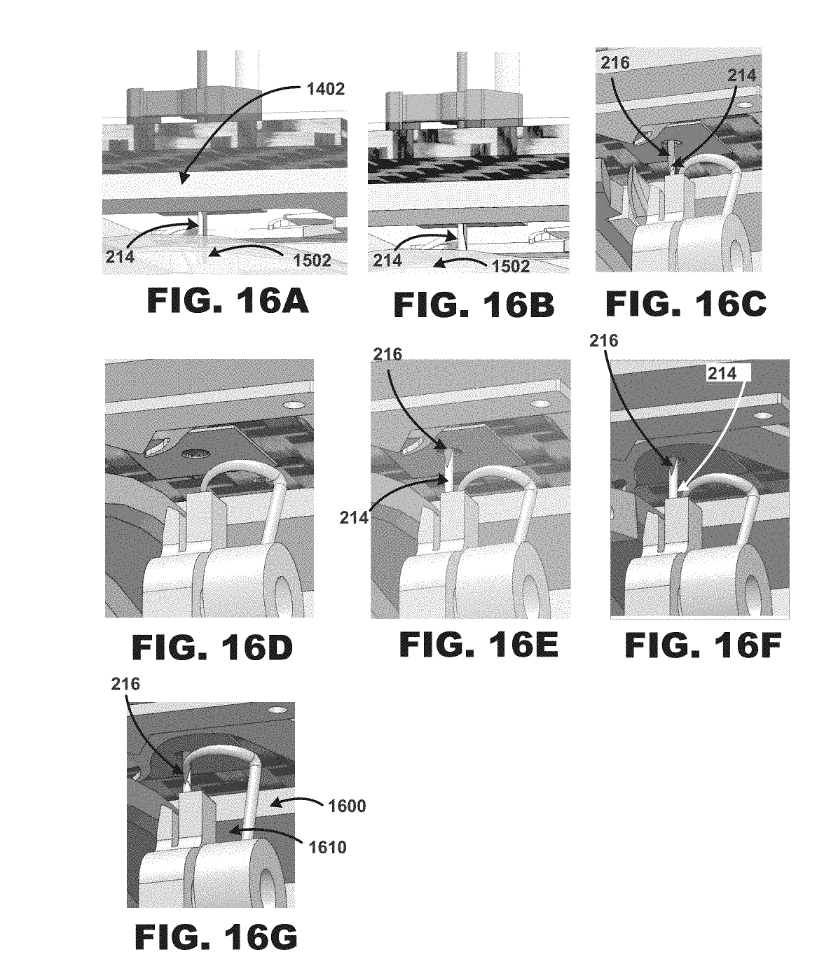

Referring to FIGS. 14A-C, FIGS. 15A-C, and FIGS. 16A-16G, as shown in FIGS. 14A-C and 5A-15C, needle 214 carries filament 1400 to lower stitching unit 1402 to rotating drum 1500 having hook 1502 through layers 1300 of composite preform 1500.

As illustrated in FIGS. 16A and 16B, once needle 214 has carried filament 1400 to lower stitching unit 1402, hook 1504 of rotating drum 1502 catches filament 1400. As illustrated in FIGS. 16E through 16G, gate 212 retracts to open the needle eye, allowing the filament to be removed from the needle 214.

In some implementations, rotating drum 1502 pulls excess filament through the composite preform layers 1300, forming a portion of the stitch, while additional arms and clamps in lower stitching unit 1402 hold portions of the filament 1400 in an appropriate position for rethreading needle 214. Meanwhile, needle 214 and gate 216 are raised above the composite preform, allowing the composite preform to be moved to a new position for the formation of the next portion of the stitch.

Once the composite preform is positioned for the next portion of the stitch, needle 214 and gate 216 may be inserted through the preform fabric layers 1300 again, this time without holding any filament 1400. Once empty needle 214 has reached the lower stitching unit 1402, gate 216 retracts to open the needle eye.

As illustrated in FIG. 16G, a rethreading fork arm 1600 and lower stitching unit arm 1610 work together to position the filament somewhat horizontally around the shaft of needle 214, causing the filament 1400 to fall back into the open needle eye. Gate 216 may then be extended to close the needle eye, and needle 214 and gate 216 are retracted with filament 1400 to pull the filament back through the preform fabric layers 1300.

Referring to FIG. 5, at 520 method 500 checks to see if composite preform processing is to be repeated. If so, method 500 returns to 514. If not, method 500 may continue to 522 to process composite preform 1500 by a molding process. Once the molding process is complete, at 524 method 500 may finish the composite preform 1500. For example, finishing a composite preform may include other processes such as sanding, sintering, cutting, painting, and the like, to finalize the composite preform part 1500. At 526, method 500 ends.

In implementations, composite preforms, layers, and laminates, may be stitched in one or more locations within the work envelope 1406, with the stitch density, stitch run length, stitch path shape, and filament type potentially varied as needed, depending on the application. Furthermore, each composite preform may pass through one or more stitch cycles, with preform fabric layers folded, preform fabric layers added, or other preform manipulation being performed before, between, or after one or more stitch cycles.

In further implementations, actuated flaps and other mechanisms on the cartridge may be used to fold fabric layers before, between, or after one or more stitch cycles to form preforms with complex geometry. Additionally, additional fabric layers may be added to a cartridge between stitch cycles to allow for more complex laminates. Furthermore, partially completed preforms may be transferred to between two or more cartridges to utilize additional fixturing, folding, and clamping. For example, as illustrated in FIG. 17A-17C fabrication apparatus 100 and method 500 as described herein may produce virtually unlimited types of composite preforms with complex 3D shapes, that are Z-axis reinforced, and composite preforms that may be used as core materials, etc. For example, FIG. 17A illustrates composite preform 1512 with a complex shape, FIG. 17B illustrates composite preform 1514 variable fabric layer thickness and ply drops, and FIG. 17C illustrates a composite preform 1516 including a lightweight core material, such as foam. All three of these example preforms include Z-axis reinforcement provided by stitching with a structural reinforcing filament, such as a carbon fiber stitching yarn. Z-axis reinforcements may be placed in selective locations to provide structural reinforcement or other enhanced properties at specific locations, as shown in preforms 1512 and 1514, or distributed substantially uniformly, as shown in preform 1516.

FIG. 18 illustrates a computer system suitable 1800 for controlling a system for three-dimensional weaving of composite preforms and products with varying cross-sectional topology according to implementations described herein. The computer system 1800 includes one or more general purpose or specialized processors 1805, which can include microprocessors, microcontrollers, system on a chip (SoC) devices, digital signal processors, graphics processing units (GPUs), ASICs, FPGAs and other programmable logic devices, and other information processing devices. The computer system 1800 also includes random access memory 1810 and non-volatile memory 1815, such as a magnetic or optical disk drive and/or flash memory devices.

The computer system 1800 may optionally include one or more visual display devices 1820. The computer system 1800 may also optionally include an audio processor 1825 for generating and receiving sound via speakers, microphone, or other audio inputs and outputs 1830; and optional sensors and input devices 1840 such as keyboards; scroll wheels; buttons; keypads; touch pads, touch screens, and other touch sensors; joysticks and direction pads; motion sensors, such as accelerometers and gyroscopes; global positioning system (GPS) and other location determining sensors; temperature sensors; such as mechanical, optical, magnetic or other types of position detectors and/or limit switches for detecting the current positions of the various components of the above-described systems; voltage, current, resistance, capacitance, inductance, continuity, or any other type of sensor for measuring electrical characteristics of the various components of the above-described systems; force, acceleration, stress or strain, and/or tension sensors; and/or any other type of input device known in the art. Computer system 1800 may optionally include one or more cameras or other optical measurement devices 1835 for capturing still images and/or video.

The computer system 1800 may also include one or more modems and/or wired or wireless network interfaces 1845 (such as the 802.11 family of network standards) for communicating data via local-area networks 1850; wide-area networks such as the Internet; CDMA, GSM, or other cellular data networks of any generation or protocol; industrial networks; or any other standard or proprietary networks. The computer system 1800 can also include a peripheral and/or data transfer interface, such as wired or wireless USB, IEEE 1394 (Firewire), Bluetooth, or other wired or wireless data transfer interfaces.

The computer system 1800 can include a power system 1855 for obtaining electrical power from an external source, such as AC line current or DC power tailored to the computer system 1800 via an external power supply, as well as one or more rechargeable or one-time use batteries, fuel cells, or any other electrical energy generation device. Additionally, power system 1855 may provide energy in the form of compressed gas, vacuum, and/or hydraulic systems to power various actuators and components of embodiments of the invention.

Computer system 1800 may be implemented in a variety of different form factors, including desktop and laptop configurations as well as embedded and headless forms.

Embodiments of the invention use a variety of motors and actuators, such as brushed or brushless DC motors, AC synchronous and induction motors, stepper motors, servomotors, solenoids, and/or pneumatic and hydraulic actuators. In an embodiment, computer system 1800 include motor and actuator controls 1060 for providing power and control signals to these motors and actuators.

Although the description has been described with respect to particular embodiments thereof, these particular embodiments are merely illustrative, and not restrictive.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a computer-readable storage medium for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

We claim:

1. A method for stitching composite preforms, the method comprising:
positioning a first carbon fiber fabric layer relative a second carbon fiber fabric layer;
determining a first Z-height stitching position relative to a Z-base position for stitching at least a portion of the first carbon fiber fabric layer to the second carbon fiber fabric layer;
positioning a needle assembly including an inner shaft, outer cover, and open needle eye portion relative to a first insertion point of the first carbon fiber fabric layer relative a second carbon fiber fabric layer forming a first fabric laminate at a first thickness;
attaching a filament to the open needle eye portion;
inserting the needle assembly including the filament through both the first and second carbon fabric layer at the first insertion location to form a first portion of a continuous stitch at the first Z-height position;
disconnecting the filament from the needle assembly;
removing the needle assembly from the first and second carbon fiber fabric layers;
moving the position of the needle assemble and the first and the second carbon fiber layer relative to one another to position the needle assembly to a second insertion point;
inserting the needle assembly through both the first and second carbon fabric layer at the second insertion location;
reattaching the filament to the open needle eye portion of the needle assembly and using the outer cover to cover the filament attachment; and
drawing the filament through both the first and second carbon fabric layer at the second insertion location to form a second portion of the continuous stitch.

2. The method of claim 1, wherein the stitch replicates a 205 hand stitch pattern.

3. The method of claim 1, further comprising:
positioning a third layer carbon fiber fabric layer relative to the second carbon fiber fabric layer disconnecting the filament from the needle assembly;
removing the needle assembly from the first and second carbon fiber fabric layers;
adjusting the position of the needle assembly to a second Z-height stitching position relative to the base position
moving the position of the needle assemble and the first and the second carbon fiber layer and the third layer relative to one another to position the needle assembly to a third insertion point;
inserting the needle assembly through the first, second, and third carbon fabric layers at the third insertion location;
reattaching the filament to the open needle eye portion of the needle assembly and using the outer cover to cover the filament attachment; and
drawing the filament through both the first, second, and third, carbon fabric layer at the second insertion location to form a third portion of the continuous stitch at the second Z-height stitching position.

4. The method of claim 1, further comprising setting the tension of the continuous stitch to allow the first carbon fiber fabric layer and the second carbon fiber fabric layer to move relative one another during composite preform processing.

5. The method of claim 1, wherein the composite preform processing includes folding the first carbon fiber fabric layer and the second carbon fiber fabric layer before positioning the needle assembly relative to the first insertion point.

6. The method of claim 1, wherein the composite preform processing includes folding the first carbon fiber fabric layer and the second carbon fiber fabric layer after forming the first portion of the continuous stitch.

7. The method of claim 1, further comprising positioning the needle assembly at a third Z-height stitching position relative to a surface height of a composite preform carbon fiber layer relative the Z-base position.

8. A method for producing composite preforms, the method comprising:
positioning a first carbon fiber fabric layer relative a second carbon fiber fabric layer to form a first laminate in a first shape;
positioning a needle assembly including an inner shaft, outer cover, and open needle eye portion relative to a first insertion point of the first carbon fiber fabric layer relative a second carbon fiber fabric layer forming a first fabric laminate at a first thickness;
attaching a filament to the open needle eye portion;
inserting the needle assembly including the filament through both the first and second carbon fabric layer at the first insertion location to form a first portion of a continuous stitch;
disconnecting the filament from the needle assembly;
removing the needle assembly from the first and second carbon fiber fabric layers;
moving the position of the needle assemble and the first and the second carbon fiber layer relative to one another to position the needle assembly to a second insertion point;
inserting the needle assembly through both the first and second carbon fabric layer at the second insertion location;
reattaching the filament to the open needle eye portion of the needle assembly and using the outer cover to cover the filament attachment;
drawing the filament through both the first and second carbon fabric layer at the second insertion location to form a second portion of the continuous stitch to bind the first laminate layer; and
folding the first laminate layer to form a second shape.

9. The method of claim 8, wherein folding the first laminate layer to form the second shape occurs prior to positioning the needle relative to the first insertion point.

10. The method of claim 8, wherein folding the first laminate layer to form the second shape occurs after forming the first portion of the continuous stitch.

11. The method of claim 8, further comprising:
determining a first Z-height stitching position relative to a Z-base position for stitching at least a portion of the first carbon fiber fabric layer to the second carbon fiber fabric layer at the first insertion point; and
positioning the needle assembly to the first Z-height stitching position.

12. The method of claim 11, adjusting the position of the needle assembly to a second Z-height stitching position relative to the Z-base position.

13. The method of claim 12, further comprising:
positioning a third layer carbon fiber fabric layer relative to the second carbon fiber fabric layer to form a second laminate layer;
disconnecting the filament from the needle assembly;
removing the needle assembly from the first and second carbon fiber fabric layers;
moving the position of the needle assemble and the first and the second carbon fiber layer and the third layer relative to one another to position the needle assembly to a third insertion point at the second Z-height stitching position;
inserting the needle assembly through the first, second, and third carbon fabric layers at the third insertion location;
reattaching the filament to the open needle eye portion of the needle assembly and using the outer cover to cover the filament attachment;
drawing the filament through both the first, second, and third, carbon fabric layer at the second insertion location to form a third portion of the continuous stitch at the second Z-height stitching position; and
folding the second laminate layer to form a third shape.

14. The method of claim 13, wherein folding the second laminate layer to form the third shape occurs prior to positioning the needle relative to the third insertion point.

15. The method of claim 13, wherein folding the second laminate layer to form the third shape occurs after forming the third portion of the continuous stitch.

16. An apparatus for forming composite preforms, the apparatus comprising:
a composite fiber stacking mechanism configured to stack a plurality of layers of carbon fiber layers to form a composite laminate;
a stitching assembly including a needle apparatus configured to stitch at least two carbon fiber layers of the stack of carbon fiber layers using a filament to bind at least a portion of the composite laminate; and
a folding apparatus configured to fold the composite laminate to form at least a portion of a composite preform.

17. The apparatus of claim 16, wherein the folding apparatus is configured to fold at least a portion of the composite laminate prior to stitching the at least two carbon fiber layers.

18. The apparatus of claim 16, wherein the folding apparatus is configured to fold at least a portion of the composite laminate after stitching the at least two carbon fiber layers.

19. The apparatus of claim 16, further comprising a cartridge configured to hold the composite preform for processing.

20. The apparatus of claim 19, wherein the cartridge includes a plurality of openings adapted to allow for the needle apparatus to access the composite preform for stitching thereof.
